(19) United States
(12) Patent Application Publication
(10) Pub. No.: US 2026/0254928 A1
(43) Pub. Date: Aug. 27, 2026

(54) COMMUNICATION APPARATUSES, CONTROL METHODS, AND RECORDING MEDIUMS

(71) Applicant: CANON KABUSHIKI KAISHA, Tokyo (JP)

(72) Inventor: KENTA WATANABE, Kanagawa (JP)

(21) Appl. No.: 19/533,914

(22) Filed: Feb. 9, 2026

(30) Foreign Application Priority Data
Feb. 25, 2025 (JP) 2025-028372

(51) Int. Cl. H04N 7/18; G06F 3/0482; G06F 3/0484; H04N 23/66

(52) U.S. Cl. CPC H04N 7/185; G06F 3/0482; G06F 3/0484; H04N 23/66

(57) ABSTRACT

One or more communication apparatuses, control methods, and storage mediums are provided herein. At least one communication apparatus includes a transmitter configured to transmit content data to an external apparatus, a display configured to display a list screen for a transmission history of the content data, a re-transmitter configured to, based on a user operation performed on the list screen to instruct retransmission of a transmission history of content data, retransmit the content data to the external apparatus, and one or more processors that operate to, in a case where the list screen includes transmission histories of the same content data, restrict a user operation of instructing the retransmission to a part of the transmission histories of the same content data.

### BACKGROUND

### Field of the Technology

The present disclosure relates to one or more embodiments of communication apparatuses, one or more embodiments of control methods, and one or more embodiments of recording mediums.

### Description of the Related Art

Applications are available that transfer images, moving images, and audio files captured and recorded by image capturing apparatuses such as digital cameras to external file transfer protocol (FTP) servers using mobile terminals such as smartphones.

The above-described applications communicate with the image capturing apparatuses and the external servers via networks and present to users information about files stored in media in the image capturing apparatuses. Further, they can acquire files selected by the users from the image capturing apparatuses and transmit them to the external servers.

These applications are primarily intended for use by photographers at news bureaus and newspaper companies to immediately deliver data of images and moving images captured at reporting sites to the company's internal servers. Since the photographers may switch the delivery destination (the server to which data is transferred) for each reporting site or type of content (still image/moving image) in capturing and delivering images, the applications provide a function of switching the transfer destination server.

On the other hand, depending on the reporting site, there may be a case where normal communication cannot be established due to issues such as a deterioration in a network environment or a server failure at the transfer destination, and the client who has requested the coverage may ask to retransmit the previously delivered content.

To address such a case, it is conceivable that the application has a function of presenting an operation history in which a history of transfer to the external server is combined with the date and time, file name, transmission destination, and transmission result, and enabling a user to retransmit a selected file to the same delivery destination again. Accordingly, it is possible to reduce a time and effort of the user to search for and reselect the file to respond to the above-described retransmission request.

With the above-described function, since the date and time are paired and presented to the user as the operation history, if the same content exists in the operation histories, the user may become confused about which one to select for retransmission.

According to Japanese Patent Laid-Open No. 2005-193447, a method is described in which, even if the same content is selected, only one item is handled as a processing target for printing in a case where duplicate contents exist in a storage medium. However, in addition to a user being uneasy with duplicate content, unnecessary communication with a storage medium may occur due to the storing, referencing, or processing of the duplicate content.

In addition to the issue that the user may become confused in making a selection, if the same content is selected, it is delivered to the transmission destination as many times as the number of the selected contents, resulting in unnecessary communication.

### SUMMARY

According to one or more aspects of the present disclosure, at least one embodiment of a communication apparatus may include a transmitter configured to transmit content data to an external apparatus, a display configured to display a list screen for a transmission history of the content data, a re-transmitter configured to, based on a user operation performed on the list screen to instruct retransmission of a transmission history of content data, retransmit the content data to the external apparatus, and one or more processors that operate to, in a case where the list screen includes transmission histories of the same content data, restrict a user operation of instructing the retransmission to a part of the transmission histories of the same content data.

According to other aspects of the present disclosure, one or more additional communication apparatuses, one or more control methods, and one or more storage mediums are discussed herein. Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating at least one embodiment of a system configuration according to one or more aspects of the present disclosure.

FIGS. 2A to 2C are block diagrams illustrating at least one embodiment of a configuration of at least one image capturing apparatus according to one or more aspects of the present disclosure.

FIGS. 3A and 3B are block diagrams illustrating at least one embodiment of a configuration of at least one communication apparatus according to one or more aspects of the present disclosure.

FIG. 4 is a diagram illustrating at least one embodiment of a structure of upload history information according to one or more aspects of the present disclosure.

FIG. 5 is a sequence diagram illustrating at least one embodiment of a retransfer operation from an upload history by at least one communication apparatus according to one or more aspects of the present disclosure.

FIG. 6 is a sequence diagram illustrating at least one embodiment of a communication between at least one communication apparatus and at least one image capturing apparatus according to one or more aspects of the present disclosure.

FIGS. 7A to 7G is a diagram illustrating one or more embodiments of display examples of at least one communication apparatus according to one or more aspects of the present disclosure.

FIG. 8 is a flowchart illustrating at least one embodiment of operations of at least one communication apparatus according to one or more aspects of the present disclosure.

FIG. 9 is a flowchart illustrating at least one embodiment of operations of at least one communication apparatus according to one or more aspects of the present disclosure.

FIG. 10 are diagrams illustrating at least one embodiment of a display example of at least one communication apparatus according to one or more aspects of the present disclosure.

### DESCRIPTION OF THE EMBODIMENTS

Embodiments of the present disclosure will be described in detail below with reference to the attached drawings.

The embodiments described below are merely examples of implementation of the present disclosure and may be appropriately modified or changed depending on configurations and various conditions of apparatuses to which the present disclosure is applied. Further, each of the embodiments may be appropriately combined.

### ONE OR MORE EMBODIMENTS

### System Configurations for One or More Embodiments

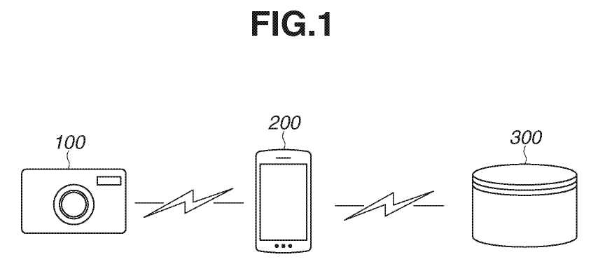

FIG. 1 is a schematic diagram illustrating at least one embodiment of a system configuration according to the present disclosure.

In FIG. 1, an image capturing apparatus 100 is a digital camera or the like. A communication apparatus 200 as a mobile terminal is an information processing apparatus having a communication function typified by a smartphone or a computer. A server 300 is an image storage apparatus that is installed at a connection destination via a communication network such as the Internet.

In FIG. 1, the image capturing apparatus 100 and the communication apparatus 200 are connected via wired or wireless communication via a connection unit such as a wired cable or Wireless Fidelity (Wi-Fi), and it is possible to transfer a moving image file generated by the image capturing apparatus 100 to the communication apparatus 200. The communication apparatus 200 and the server 300 are connected via a communication unit such as mobile data communication, and information stored in the communication apparatus 200 may be transferred to the server 300 via communication such as a file transfer protocol (FTP).

The system configuration is not limited to this, and, for example, the image capturing apparatus 100, the communication apparatus 200, and the server 300 may be connected to the same network via an access point without using mobile data communication to realize file transfer processing between each apparatus.

### Configurations of Image Capturing Apparatus 100 for One or More Embodiments

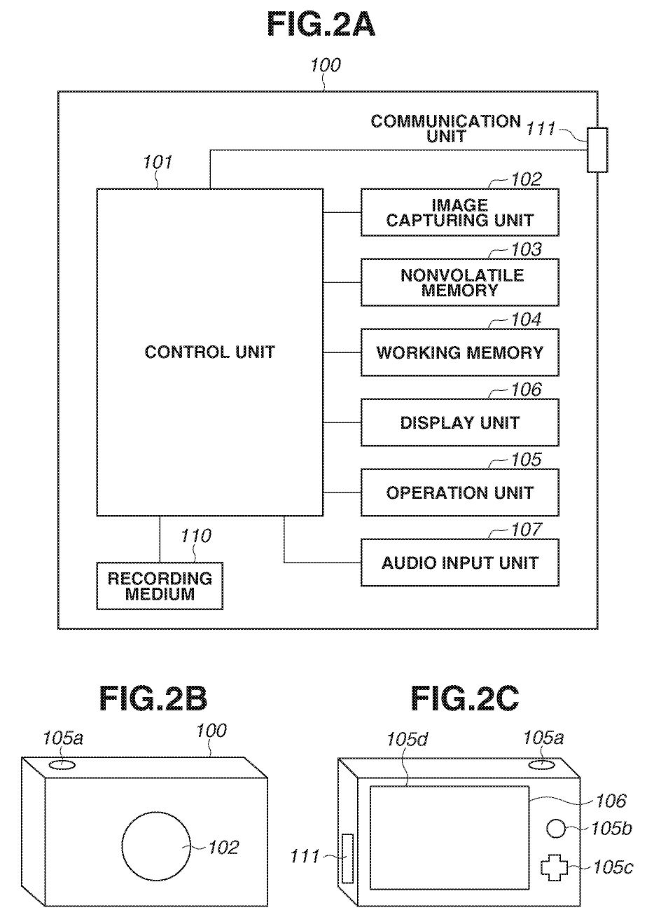

FIG. 2A is a block diagram illustrating a hardware configuration example of the image capturing apparatus 100 according to one or more embodiments. Here, a digital camera is described as an example of the image capturing apparatus 100, but the image capturing apparatus 100 is not limited to a digital camera. For example, the image capturing apparatus 100 may be an information processing apparatus such as a portable media player, a tablet device, or a personal computer.

A control unit 101 controls each unit of the image capturing apparatus 100 according to an input signal and a program described below. Instead of the control unit 101 controlling the entire image capturing apparatus 100, a plurality of hardware components may share the processing and control the entire apparatus.

An image capturing unit 102 is configured with, for example, an optical lens unit, an optical system that controls aperture, zoom, focus, and the like, an image sensor that converts light (video) introduced through the optical lens unit into an electrical video signal, and the like. As the image sensor, a complementary metal oxide semiconductor (CMOS) and a charge coupled device (CCD) are generally used. Under the control of the control unit 101, the image capturing unit 102 converts subject light formed by a lens included therein into an electrical signal using the image sensor, performs noise reduction processing and the like, and outputs the resulting digital data as moving image data. In the image capturing apparatus 100 according to one or more embodiments, moving image data is recorded on a recording medium 110.

A nonvolatile memory 103 is an electrically erasable and recordable nonvolatile memory, and stores a program executed by the control unit 101, which is described below, metadata template information, and the like.

A working memory 104 is used as a buffer memory for temporarily storing moving image data captured by the image capturing unit 102, a moving image display memory for a display unit 106, a work area for the control unit 101, and the like.

An operation unit 105 is used to receive an instruction from a user to the image capturing apparatus 100. The operation unit 105 includes, for example, a power button for the user to instruct the image capturing apparatus 100 to be turned on/off, a release switch to instruct start and stop of image capturing, and a reproducing button to instruct reproduction of moving image data. The operation unit 105 further includes an operation member such as a dedicated connection button for starting communication with an external device via a communication unit 111, which is described below. A touch panel formed on the display unit 106, which is described below, is also included in the operation unit 105.

The display unit 106 displays a viewfinder image during image capturing, captured moving image data, text for interactive operation, and the like. The display unit 106 is not necessarily required to be built into the image capturing apparatus 100. The image capturing apparatus 100 may be connected to an internal or external display or display unit 106 and may have at least a display control function of controlling the display on the display or display unit 106.

An audio input unit 107 is a device for inputting audio information, and audio data converted from the audio information by the audio input unit 107 is recorded on the recording medium 110 in an audio file format.

The recording medium 110 is capable of recording the moving image data output from the image capturing unit 102 and the audio data output from the audio input unit 107. The recording medium 110 may be configured to be detachable from, or built into the image capturing apparatus 100. In other words, it is sufficient for the image capturing apparatus 100 to include at least a unit to access the recording medium 110.

The communication unit 111 is an interface for connecting to an external apparatus. The image capturing apparatus 100 according to one or more embodiments is capable of exchanging data with the external apparatus via the communication unit 111. For example, the moving image data generated by the image capturing unit 102 and the audio data generated by the audio input unit 107 may be transmitted to the external apparatus via the communication unit 111. According to one or more embodiments, the communication unit 111 includes an interface for communicating with the external apparatus via a wireless local area network (LAN) in accordance with the Institute of Electrical and Electronics Engineers (IEEE) 802.11 standard. The communication unit 111 also includes a Universal Serial Bus (USB) interface for connecting to the external apparatus via a USB cable. The control unit 101 controls the communication unit 111 to realize wireless communication and wired communication with the external apparatus.

The communication unit 111 of the image capturing apparatus 100 according to one or more embodiments has an access point mode (hereinbelow, referred to as AP mode) in which it operates as an access point in an infrastructure mode. Further, the communication unit 111 has a client mode (hereinbelow, referred to as CL mode) in which it operates as a client in the infrastructure mode. Furthermore, by operating the communication unit 111 in the CL mode, the image capturing apparatus 100 according to one or more embodiments may operate as a CL device in the infrastructure mode. In a case where the image capturing apparatus 100 operates as the CL device, it may participate in a network formed by a surrounding AP device by connecting to it. Further, by operating the communication unit 111 in the AP mode, the image capturing apparatus 100 according to one or more embodiments may also operate as a simplified AP (hereinbelow, referred to as simple AP), which is a type of AP with more limited functionality.

If the image capturing apparatus 100 operates as the simple AP, it forms a network by itself. A device around the image capturing apparatus 100 may recognize it as the AP device and participate in the network formed by the image capturing apparatus 100. It is assumed that a program for operating the image capturing apparatus 100 as described above is stored in the nonvolatile memory 103.

Although the image capturing apparatus 100 according to one or more embodiments is a type of AP, it is a simple AP that does not have a gateway function of transferring data received from the CL device to an Internet provider or the like. Thus, even if the image capturing apparatus 100 receives data from another device participating in the network that it has formed, it cannot transfer the received data to a network such as the Internet.

Next, an external appearance of the image capturing apparatus 100 is described. FIGS. 2B and 2C illustrate examples of the external appearance of the image capturing apparatus 100. A release switch 105a, a reproducing button 105b, a directional key 105c, and a touch panel 105d are operation members included in the above-described operation unit 105. Further, the display unit 106 displays a moving image obtained as a result of image capturing by the image capturing unit 102.

The image capturing apparatus 100 has been described above.

### Hardware Configurations of Communication Apparatus 200 for One or More Embodiments

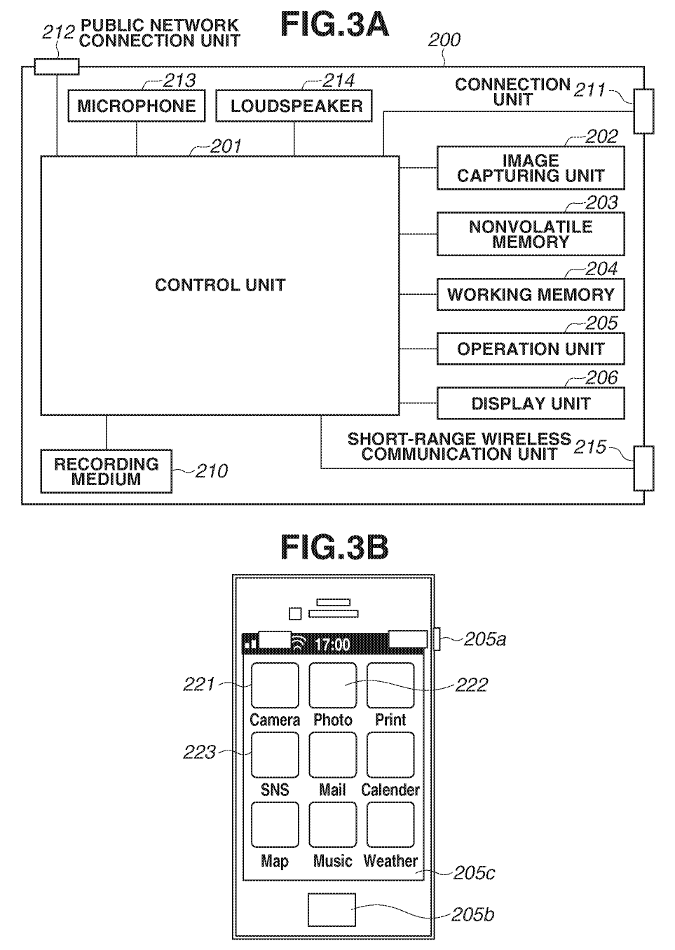

FIG. 3A is a block diagram illustrating a configuration example of the communication apparatus 200, which is an example of a communication apparatus according to one or more embodiments. Here, a mobile device is described as an example of the communication apparatus 200, but the communication apparatus 200 is not limited thereto. For example, the communication apparatus 200 may be an information processing apparatus such as a digital camera with wireless functionality, a portable media player, a tablet device, a personal computer, or a smartphone.

A control unit 201 controls each unit of the communication apparatus 200 according to an input signal and a program described below. Instead of the control unit 201 controlling the entire communication apparatus 200, a plurality of hardware components may share the processing and control the entire apparatus.

An image capturing unit 202 converts subject light formed by a lens included therein into an electrical signal, performs noise reduction processing and the like, and outputs the resulting digital data as image data. The captured image data is stored in a buffer memory, then subjected to a predetermined calculation by the control unit 201, and recorded on a recording medium 210.

A nonvolatile memory 203 is an electrically erasable and recordable nonvolatile memory, and stores an operating system (OS), which is basic software executed by the control unit 201, various programs, and the like. It is assumed that a program for communicating with the digital camera 100 is also stored in the nonvolatile memory 203 and installed as a camera communication application. Processing by the communication apparatus 200 according to one or more embodiments is realized by reading a program provided by the camera communication application. It is assumed that the camera communication application includes a program for using basic functions (for example, a wireless LAN function, a Bluetooth® function, a function of calling another application, and the like) of the OS installed in the communication apparatus 200. The camera communication application also has a remote shooting function that enables the communication apparatus 200 to remotely control the digital camera 100 to capture an image while viewing a live view image acquired from the digital camera 100. Further, the camera communication application has a remote browsing function that enables the communication apparatus 200 to remotely browse image data recorded in the recording medium 110 mounted in the digital camera 100 and receive the image data.

The OS of the communication apparatus 200 may include a program for realizing processing according to one or more embodiments.

A working memory 204 is used as a buffer memory for temporarily storing image data generated by the image capturing unit 202, an image display memory for a display unit 206, a work area of the control unit 201, and the like.

An operation unit 205 is used to receive an instruction from a user to the communication apparatus 200. The operation unit 205 includes, for example, operation members such as a power button for the user to instruct the communication apparatus 200 to be turned on/off and a touch panel formed on the display unit 206.

The display unit 206 displays image data, text for interactive operation, and the like. The display unit 206 is not necessarily required to be built into the communication apparatus 200. The communication apparatus 200 may be connected to the display or display unit 206 and may have at least a display control function of controlling the display on the display or display unit 206.

The recording medium 210 is capable of recording the image data output from the image capturing unit 202 and the image data received from a data processing apparatus. The recording medium 210 may be configured to be detachable from, or built into the communication apparatus 200. In other words, it is sufficient for the communication apparatus 200 to include at least a unit to access the recording medium 210.

A connection unit 211 is an interface for connecting to an external apparatus. The communication apparatus 200 according to one or more embodiments is capable of exchanging data with the external apparatus via the connection unit 211. According to one or more embodiments, the connection unit 211 includes an interface for communicating with an external device interface. The control unit 201 controls the connection unit 211 to realize wireless communication with the external apparatus. The digital camera 100 according to one or more embodiments is capable of operating at least as a slave device in the infrastructure mode of wireless LAN communication and participating in a network formed by a surrounding AP.

A public network connection unit 212 is an interface used for performing public wireless communication.

The communication apparatus 200 is capable of making a call and performing data communication with another device via the public network connection unit 212. If making a call, the control unit 201 inputs and outputs audio signals via a microphone 213 and a loudspeaker 214. According to one or more embodiments, the public network connection unit 212 is assumed to include an interface for performing communication using the third generation mobile communication system (3G). It is not limited to 3G, and other communication methods such as Long Term Evolution (LTE), Worldwide Interoperability for Microwave Access (WiMAX), Asymmetric Digital Subscriber Line (ADSL), Fiber To The Home (FTTH), or the fourth generation mobile communication system (4G) may also be used. Further, the connection unit 211 and the public network connection unit 212 are not necessarily required to be configured as independent hardware, and, for example, a single antenna may serve as both units.

A short-range wireless communication unit 215 is an interface for establishing short-range wireless communication with another external apparatus. The communication apparatus 200 according to one or more embodiments is capable of exchanging data with the other external apparatus via the short-range wireless communication unit 215. According to one or more embodiments, the short-range wireless communication unit 215 includes an interface for communicating with the other external apparatus via a Bluetooth® interface.

The control unit 201 controls the short-range wireless communication unit 215 to realize Bluetooth® communication with the other external apparatus.

Next, an external appearance of the communication apparatus 200 is described. FIG. 3B illustrates an example of the external appearance of the communication apparatus 200. A power supply button 205a, a home button 205b, and a touch panel 205c are operation members included in the above-described operation unit 205. If a user presses the home button 205b, the use of the currently running application is paused, and a home screen from which another application may be selected may be displayed on the display unit 206.

On the home screen of the communication apparatus 200, items corresponding to respective applications are arranged that enable the user to launch each application or call an application running in the background. For example, an item 221 is a camera communication application item for the communication apparatus 200 to communicate with the digital camera 100 according to one or more embodiments. An item 222 is an image display application item for the user to browse images stored in the communication apparatus 200. An item 223 is a social network service (SNS) application item for the communication apparatus 200 to communicate with the server 300 and share an image, a text, and the like with other users. According to one or more embodiments, the camera communication application is an application provided by a manufacturer of the digital camera 100 via an application distribution site. Further, the image display application is assumed to be an application preinstalled in the communication apparatus 200 (in other words, an application that is built-in as standard on the OS of the communication apparatus 200). The SNS application is an application provided by its developer via the application distribution site.

On the home screen, for example, if the item 221 is pressed (touched) and the camera communication application has not yet been launched, it is newly launched and its screen is displayed. In a case where the application is already running in the background, the application is not launched again, but is brought to the foreground, and its screen is displayed again.

The communication apparatus 200 is capable of switching or executing an application without going through the home screen by inputting a specific instruction into the OS. At this time, the currently running application is brought to the background if the specific instruction is input. Further, the application that is instructed to be switched to is either newly launched or brought from the background to the foreground to operate.

The communication apparatus 200 has been described above.

Hereinbelow, the communication apparatus 200 may be described as if it is a processing entity, but in reality, the control unit 201 reads a program stored in the nonvolatile memory 203 and realizes various types of processing. Similarly, in portions where the digital camera 100 is described as if it is a processing entity, the control unit 101 reads a program stored in the nonvolatile memory 103 and realizes various types of processing.

### Descriptions of Upload History Information for One or More Embodiments

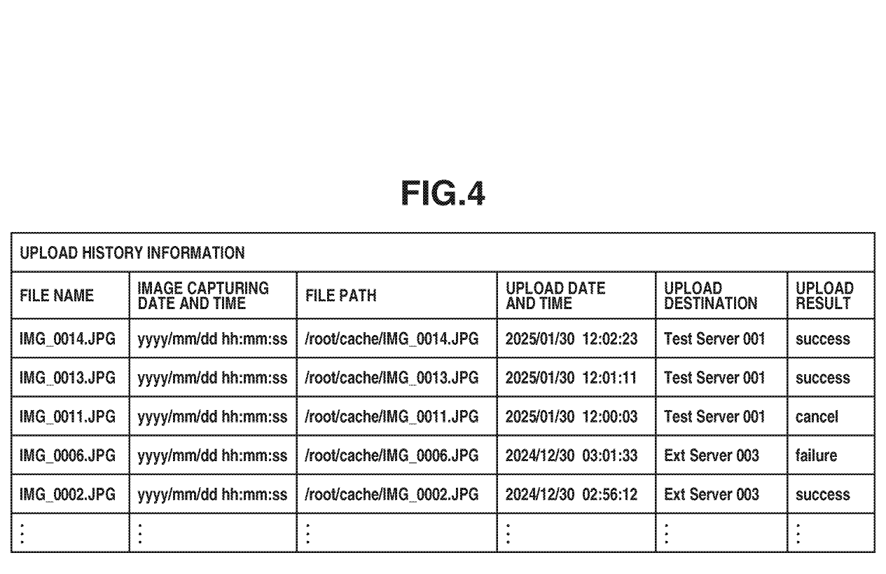

Next, a data format of upload history information to be stored in the communication apparatus 200 according to one or more embodiments is described with reference to FIG. 4.

According to one or more embodiments, a process in which the communication apparatus 200, which serves as the entity, receives data from the image capturing apparatus 100 and stores it in an application-specific folder in the nonvolatile memory 203 is expressed as a download.

Further, a process in which the communication apparatus 200 transmits data received from the image capturing apparatus 100 or data stored in a specific folder in the nonvolatile memory 203 to the external server 300 is expressed as an upload.

As illustrated in FIG. 4, upload history information includes a file name, image capturing date and time, a file path, upload date and time, an upload destination, and an upload result, and each item is stored in the nonvolatile memory 203 for each uploaded file. Although not illustrated in FIG. 4, the upload history information may also include a thumbnail.

The three items, file name, image capturing date and time, and thumbnail are data or information for identifying the file on an upload history screen, which is described below.

According to one or more embodiments, since an image file captured by the image capturing apparatus 100 is mainly handled, the above-described three items are used as the information for identifying the file. However, other information or data may be adopted for identification taking into account a case where data other than image is handled.

The file name is a name of a file.

The image capturing date and time is information about the date and time when the image was captured and is included in metadata of the file.

The thumbnail is image data of a thumbnail of the image and is included in the metadata of the file.

The file path is data indicating a path of the file body stored in the nonvolatile memory 203.

The upload date and time is information about the date and time when the upload was executed.

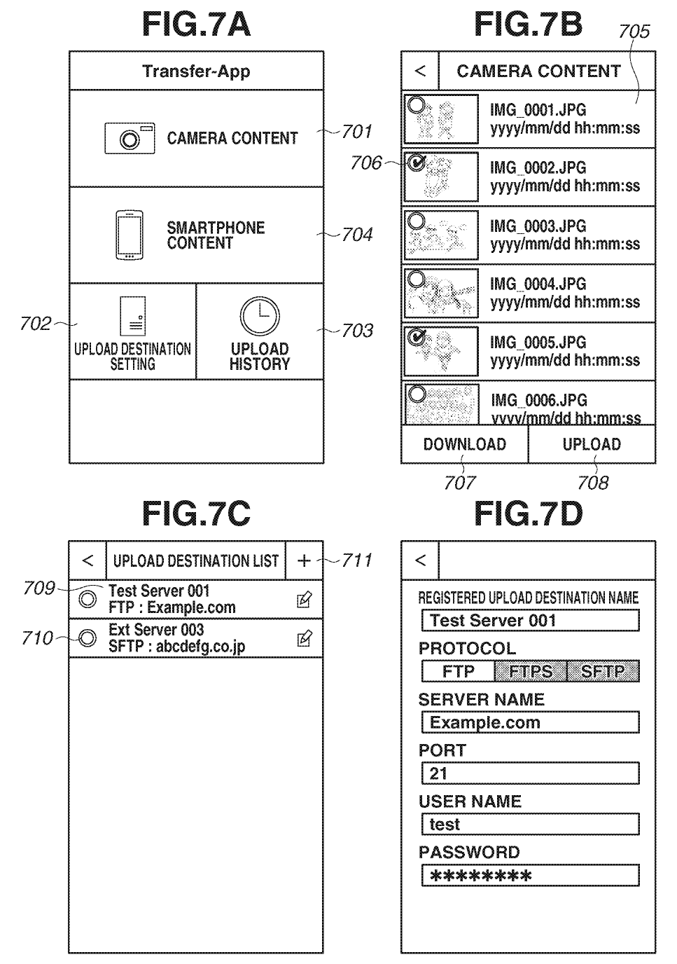

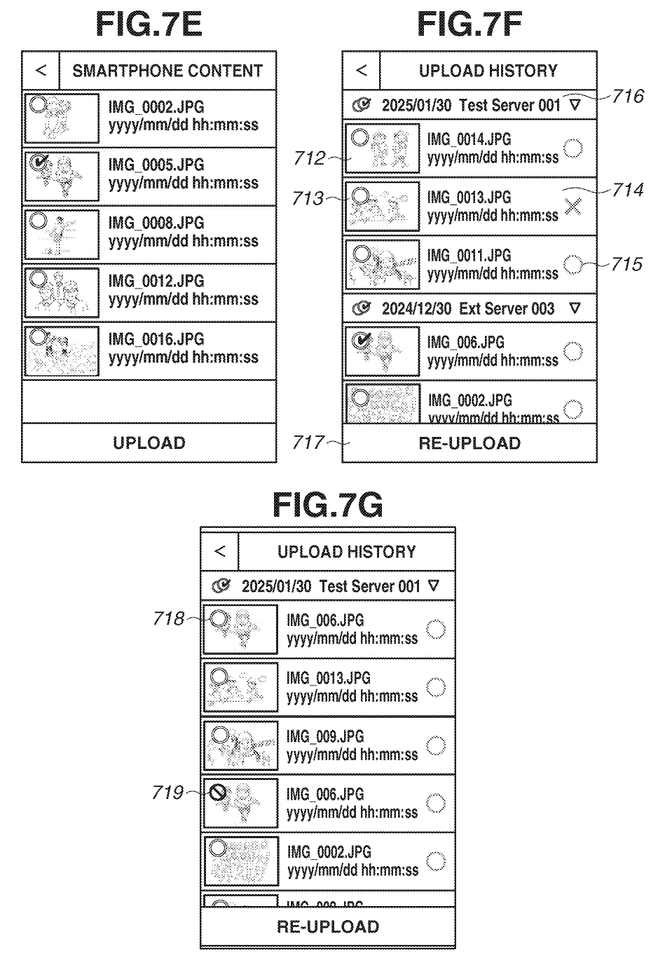

The upload destination is a collection of various setting values for specifying the upload destination, which may be set in a screen in FIG. 7E described below. Examples of the setting values are described below with reference to FIG. 7D.

The upload result is the result obtained by executing the upload. The upload result is information indicating whether the upload was successful, failed, or was canceled during the upload.

### Processing Sequences of Image Capturing Apparatus 100 and Communication Apparatus 200 for One or More Embodiments

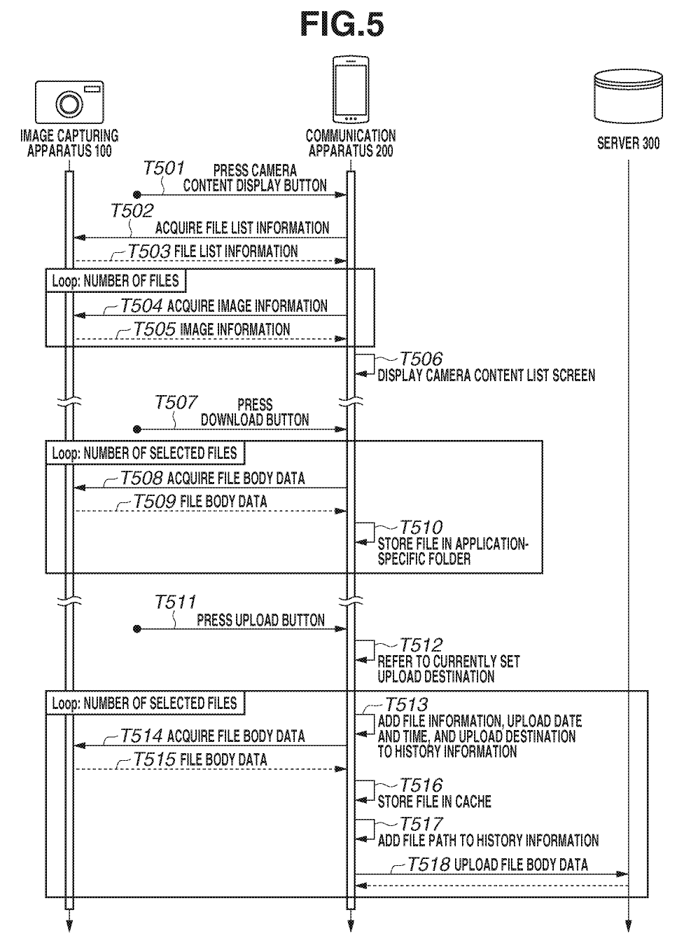

Here, processing in which the communication apparatus 200 selects and acquires an image recorded by the image capturing apparatus 100 and transmits it to the server 300 is described with reference to a sequence diagram in FIG. 5 and display screen diagrams of the communication apparatus 200 in FIGS. 7A to 7G. The present sequence is started at a timing when connection is established between the communication apparatus 200 and the image capturing apparatus 100. At this time, a screen as illustrated in FIG. 7A is displayed on the display unit 206 of the communication apparatus 200.

In transaction T501, a user operates the communication apparatus 200 and presses a camera content display button 701 illustrated in FIG. 7A.

In transaction T502, the communication apparatus 200 transmits a request to acquire file list information to the image capturing apparatus 100 via the connection unit 211.

In transaction T503, the communication apparatus 200 receives the file list information from the image capturing apparatus 100 via the connection unit 211. The file list information includes file identification information. For example, the file list information includes identifications (IDs) of a plurality of image files stored in the image capturing apparatus 100.

In transaction T504, the communication apparatus 200 transmits requests to acquire image information to the image capturing apparatus 100 via the connection unit 211 for the number of files based on the file list information received in transaction T503.

In transaction T505, the communication apparatus 200 receives the image information from the image capturing apparatus 100 via the connection unit 211.

Transactions T504 and T505 are repeated a number of times equal to the number of files included in the file list information acquired in transaction T503.

In transaction T506, the communication apparatus 200 displays a thumbnail image and image information arranged in a list (hereinbelow referred to as image list display) in a display area of the display unit 206, as illustrated in an item 705 in FIG. 7B. The user may move the display area by performing a scrolling operation on the display unit 206. Further, if the user presses a selection portion 706 as illustrated in FIG. 7B, the content of the image capturing apparatus 100 may be set as a selection target. In a state where the selection target is present, pressing a download button 707 starts a download, and pressing an upload button 708 starts an upload.

Transactions T507 to T510 illustrate a flow of processing for downloading the file selected by the user from the image capturing apparatus 100 to the communication apparatus 200.

In transaction T507, the user presses the download button 707 as illustrated in FIG. 7B. In transaction T508, the communication apparatus 200 transmits a request to acquire file body data to the image capturing apparatus 100 via the connection unit 211.

In transaction T509, the communication apparatus 200 receives the file body data from the image capturing apparatus 100 via the connection unit 211.

In transaction T510, the communication apparatus 200 stores the file in the application-specific folder arranged in the nonvolatile memory 203.

Transactions T511 to T518 illustrate a flow of processing for acquiring the file body of the file selected by the user from the image capturing apparatus 100 to the communication apparatus 200 and further uploading it from the communication apparatus 200 to the server 300.

In transaction T511, the user presses the upload button 708 as illustrated in FIG. 7B.

In transaction T512, the communication apparatus 200 refers to a currently set upload destination.

Here, a plurality of upload destinations may be registered in the communication apparatus 200 and switched therebetween. Specifically, the user presses an upload destination setting button 702 illustrated in FIG. 7A, and the screen transitions to an upload destination list screen illustrated in FIG. 7C. On this screen, the upload destination, which has already been registered is displayed in a format such as a list display 709. Further, if a plurality of upload destinations exists, they may be switched therebetween by pressing a selection button 710. In a case where it is desired to add a new upload destination, an upload destination setting screen as illustrated in FIG. 7D may be displayed by pressing an addition button 711.

Then, a new upload destination may be set by inputting a registered upload destination name, a protocol, a server name, a port number, login information (a user name and a password) set to the server.

In transaction T513, the communication apparatus 200 refers to information about the currently set upload destination and adds the file information, the upload date and time, and the upload destination to the upload history information described with reference to FIG. 4.

In transaction T514, the communication apparatus 200 transmits a request to acquire the file body data to the image capturing apparatus 100 via the connection unit 211.

In transaction T515, the communication apparatus 200 receives the file body data from the image capturing apparatus 100 via the connection unit 211.

In transaction T516, the communication apparatus 200 stores the file in a cache allocated to the working memory 204.

In transaction T517, the communication apparatus 200 adds the file path stored in transaction T516 to the upload history information.

In transaction T518, the communication apparatus 200 transmits the file body data stored in transaction T516 to the server 300 via the connection unit 211.

As described above, the communication apparatus 200 is capable of downloading the file data stored in the image capturing apparatus 100 and storing it within itself. The communication apparatus 200 is also capable of uploading the acquired file data to the server 300. If the file data is uploaded, it is stored each time in an upload history as illustrated in FIG. 4, which enables the user to check the history after transmission and retransmit the file data if necessary.

According to one or more embodiments, an example is described in which the file body data is acquired from the image capturing apparatus 100 and transmitted to the server 300, but the present disclosure is not limited thereto. For example, the user presses a smartphone content button 704 illustrated in FIG. 7A to display a list of content data stored in the nonvolatile memory 203 of the communication apparatus 200 as illustrated in FIG. 7E. Then, the user may select the content data from the list and transmit it to the server 300.

### Sequences for Retransferring from Upload History of Communication Apparatus 200 for One or More Embodiments

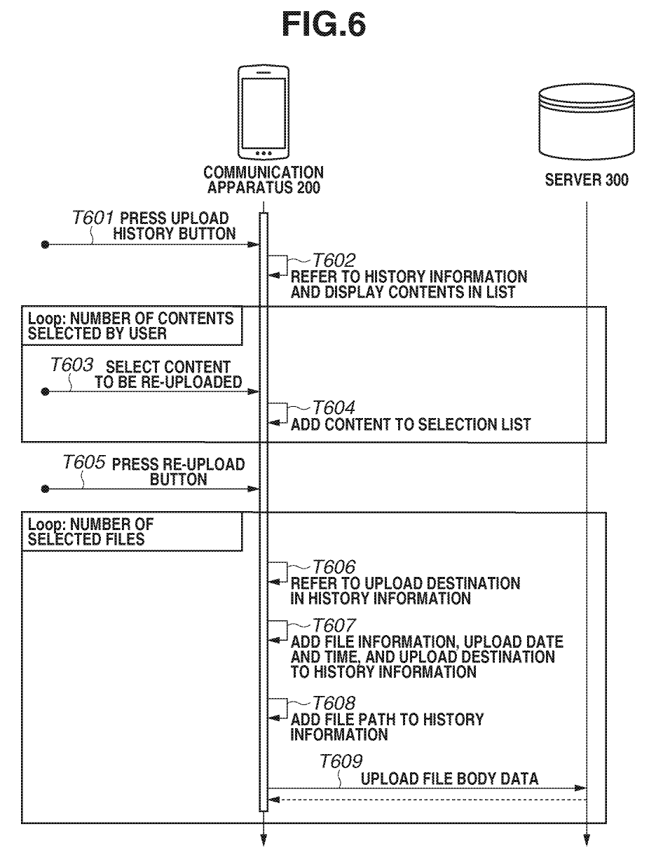

Here, processing in which the communication apparatus 200 performs retransfer from the upload history is described with reference to a sequence diagram in FIG. 6 and the display screen diagrams of the communication apparatus 200 in FIGS. 7A to 7G. The present sequence is started at a timing when the camera communication application is launched in the communication apparatus 200. At this time, the screen as illustrated in FIG. 7A is displayed on the display unit 206 of the communication apparatus 200.

In transaction T601, a user operates the communication apparatus 200 and presses an upload history button 703 illustrated in FIG. 7A. The upload history screen as illustrated in FIG. 7F is displayed on the display unit 206 of the communication apparatus 200.

In transaction T602, the communication apparatus 200 refers to the history information and displays the contents in a list on the display unit 206. At this time, the communication apparatus 200 displays a thumbnail image 712 based on the file body data stored in the file path in the history information on a content information display unit 714 with reference to the image capturing date and time and the file name. Further, an upload result icon 715 is displayed based on information about the upload result of the history information. Furthermore, the contents having the same upload date and time information are displayed as a single group as illustrated in a section 716. A set in which the content is associated with the date in this way is an example of a transmission history.

In transaction T603, the user operates the communication apparatus 200 to select the content to be re-uploaded. At this time, the user may select a re-upload target by pressing a selection portion 713 illustrated in FIG. 7F. Such an operation of selecting the selection portion 713 is an example of a first user operation. A position of the selection portion 713 is not limited as long as it is within a range of the transmission history. For example, all areas included in the range of the transmission history may function as the selection portion 713.

In transaction T604, the communication apparatus 200 adds the content selected as the re-upload target to a selection list.

Transactions T603 and T604 are repeated a number of times equal to the number of contents selected by the user in transaction T603.

In transaction T605, the user presses a re-upload button 717 illustrated in FIG. 7F. Here, an operation of pressing the re-upload button 717 is an example of a second user operation of determining a re-upload.

In transaction T606, the communication apparatus 200 searches the history information for the content with matching file name and image capturing date and time and refers to the upload destination of the history.

In transaction T607, the communication apparatus 200 refers to transaction T606 and adds the file information, the upload date and time, and the upload destination to the upload history information, which is described with reference to FIG. 4.

In transaction T608, the communication apparatus 200 adds the file path of the file body data to the upload history information.

In transaction T609, the communication apparatus 200 transmits the file body data to the server 300 via the connection unit 211.

Transactions T606 to T609 are repeated a number of times equal to the number of contents selected by the user in transaction T603.

As described above, the communication apparatus 200 allows the user to arbitrarily select the content that has already been uploaded using the upload history information, and thus may upload the content again.

The upload history screen illustrated in FIG. 7F has a function of a transfer history that displays the upload result for the content. Further, the upload history screen has a function of an operation history that displays the thumbnail image, the file name, the image capturing time, upload execution time, and the like to indicate when and what content the user transmitted.

As described so far, if a user desires or has a plan to re-upload a content that has been already uploaded to the server 300, he or she may re-upload the desired content by selecting it on the upload history screen. At this time, the upload history screen may display the same content depending on the uploaded content. In such a case, the user proceeds to determine whether the content is the same or different by carefully observing the thumbnail image 712 and the content information display unit 714 so as not to upload the same content a plurality of times.

Thus, according to one or more embodiments, even if a plurality of the same contents exists on the upload history screen, the user is restricted from performing an operation to instruct retransmission of a part of the same content. Accordingly, the user may easily select a content.

### Processing Flows of Communication Apparatuses for One or More Embodiments

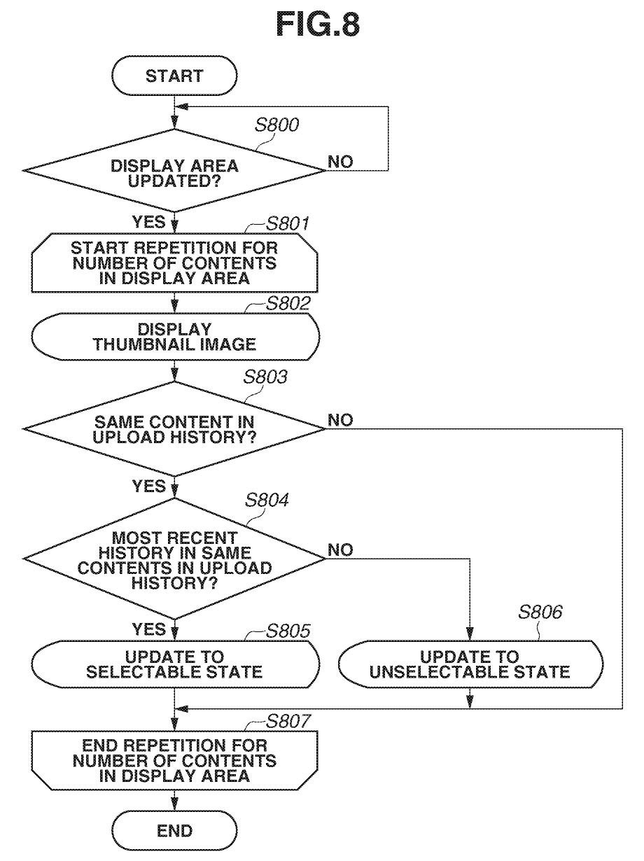

FIG. 8 is a flowchart illustrating processing performed in the communication apparatus 200 for enabling a user to easily select a re-upload target, even if a plurality of duplicate contents exists on the upload history screen in selecting the re-upload target.

Processing in the flowchart starts at the timing of transaction T602 in FIG. 6.

In step S800, the control unit 201 determines whether the display unit 206 is updated. On the other hand, if the control unit 201 determines that the display unit 206 is not updated (NO in step S800), the processing is put on hold.

Here, the update specifically refers to a case where the display area is changed at a timing immediately after transitioning to the upload history screen, if a user performs a scroll operation on the display unit 206, or the like.

In step S801, the control unit 201 starts repetitive processing from step S802 to step S807 a number of times equal to the number of contents in the display area.

In step S802, the control unit 201 displays a thumbnail image. This is referred to as a current content.

In step S803, the control unit 201 refers to the upload history stored in the nonvolatile memory 203 and searches for a history having a file name and image capturing date and time that match those of the current content. If the control unit 201 determines that a matching history exists (YES in step S803), it is stored in the working memory 204 as a matching history group, and the processing proceeds to step S804. On the other hand, if the control unit 201 determines that there is no matching history (NO in step S803), the processing proceeds to step S807.

In step S804, the control unit 201 determines whether the current content is the most recent history among the history group acquired in step S803. Specifically, the control unit 201 refers to the upload date and time of the history information and determines whether the current content is the most recent history. If the control unit 201 determines that it is the most recent history (YES in step S804), the processing proceeds to step S805. On the other hand, if the control unit 201 determines that it is not the most recent history (NO in step S804), the processing proceeds to step S806.

In step S805, the control unit 201 displays a selectable icon 718 indicating a selectable state on the current content, as illustrated in FIG. 7G.

In step S806, the control unit 201 displays a non-selectable icon 719 indicating a non-selectable state on the current content, as illustrated in FIG. 7G.

In step S807, the control unit 201 determines whether the repetitive processing has been executed a number of times equal to the number of contents in the display area. If it is determined that the processing has been executed, the processing is terminated. On the other hand, if it is determined that the processing is not yet terminated, the processing returns to step S802.

As described above, if the upload history is displayed, a selectable state of each history is switched by referring to the upload history information stored in the nonvolatile memory 203 and determining whether the content is the same and is the most recent content in the history. In this manner, even if a plurality of the same contents exists on the upload history screen in selecting a re-upload target, it becomes possible for a user to easily select the re-upload target.

According to one or more embodiments, in a case where duplicate content exists and is not the most recently uploaded content, the non-selectable icon 719 is displayed thereon, but the present disclosure is not limited thereto. For example, instead of the non-selectable icon 719, background color of the content information display unit 714 may be changed and the selectable icon 718 may be hidden. Accordingly, even if a plurality of the same contents exists, a user may easily select a content.

### One or More Additional Embodiments

According to the aforementioned one or more embodiments, an example is described in which a user may easily perform an operation of selecting a re-upload target by switching a selectable state of each history if the upload history is displayed. According to one or more additional embodiments, an example is described in which a user may easily perform an operation of selecting a re-upload target without switching a selectable state of each history if the upload history is displayed.

### Processing Flow of at least one Communication Apparatus for One or More Additional Embodiments

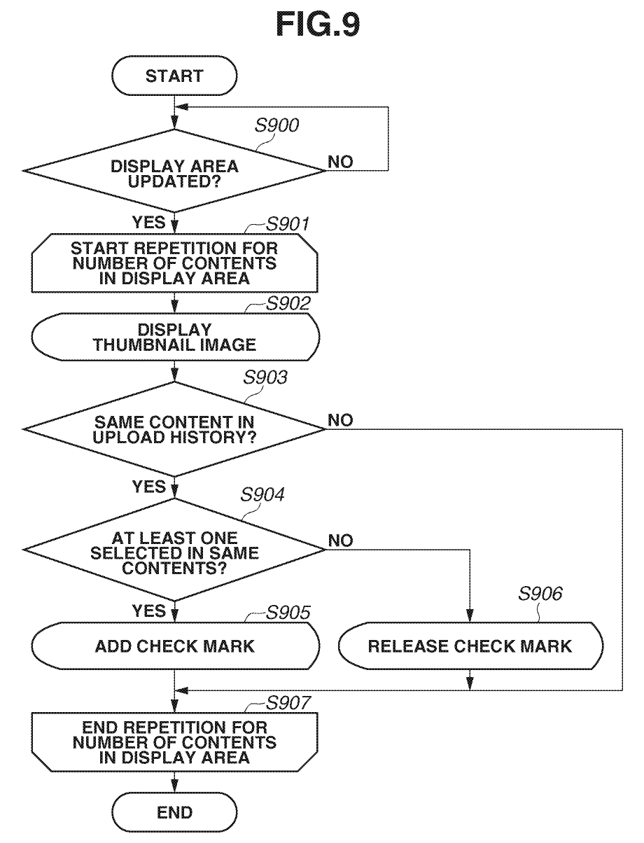

FIG. 9 is a flowchart illustrating processing performed in the communication apparatus 200 for enabling a user to easily select a re-upload target without switching a selectable state of each history, even if a plurality of duplicate contents exists on the upload history screen in selecting the re-upload target.

Processing in the flowchart starts at the timing of transaction T602 in FIG. 6.

In step S900, the control unit 201 determines whether the display unit 206 is updated. On the other hand, if the control unit 201 determines that the display unit 206 is not updated (NO in step S900), the processing is put on hold.

Here, the update specifically refers to a case where the display area is changed at a timing immediately after transitioning to the upload history screen, if a user performs a scroll operation on the display unit 206, or the like.

In step S901, the control unit 201 starts repetitive processing from step S902 to step S907 a number of times equal to the number of contents in the display area.

In step S902, the control unit 201 displays a thumbnail image. This is referred to as a current content.

In step S903, the control unit 201 refers to the upload history stored in the nonvolatile memory 203 and searches for a history having a file name and image capturing date and time that match those of the current content. If the control unit 201 determines that the matching history exists (YES in step S903), it is stored in the working memory 204 as a matching history group, and the processing proceeds to step S904. On the other hand, if the control unit 201 determines that there is no matching history (NO in step S903), the processing proceeds to step S907.

In step S904, the control unit 201 determines whether at least one content is already selected among the history group acquired in step S903. If the control unit 201 determines that the content is already selected (YES in step S904), the processing proceeds to step S905. On the other hand, if the control unit 201 determines that the content is not yet selected (NO in step S904), the processing proceeds to step S906.

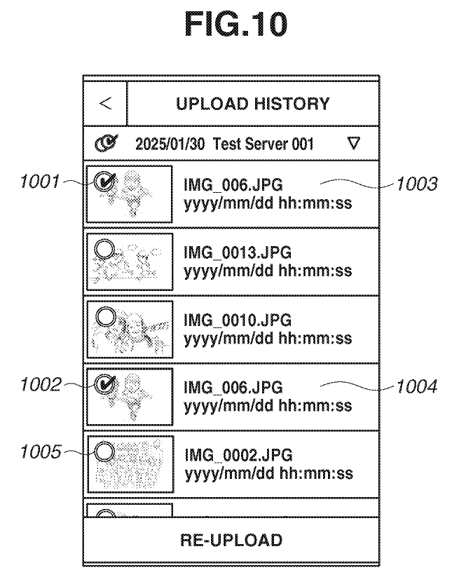

In step S905, the control unit 201 displays a selected icon 1002 indicating a selected state on the current content, as illustrated in FIG. 10. The example in FIG. 10 illustrates a state where contents 1003 and 1004 are the same content, a user selects one of the contents as a re-upload target, and the selected icon 1002 is added to both contents.

In step S906, the control unit 201 displays an unselected icon 1005 indicating an unselected state on the current content.

In step S907, the control unit 201 determines whether the repetitive processing has been executed a number of times equal to the number of contents in the display area. If it is determined that the processing has been executed, the processing is terminated. On the other hand, if it is determined that the processing is not yet terminated, the processing returns to step S902.

As described above, if the upload history is displayed, each history is switched between the selected state and the unselected state by referring to the upload history information and determining whether the content is duplicate and whether the selected content exists in the history. In this manner, even if a plurality of duplicate contents exists on the upload history screen in selecting a re-upload target, it becomes possible for a user to easily select the re-upload target without duplicately or repeatedly selecting the content.

The selected icon 1002 is not limited to the example illustrated in FIG. 10. There is no particular limitation as long as the re-upload target may be identified.

While the present disclosure has been described above with reference to the embodiments, it is to be understood that the present disclosure is not limited to these embodiments, and various modifications and changes may be made within the scope of the gist of the present disclosure.

According to the above-described embodiments, whether a file is a chunk recording file is determined using a file naming rule. However, the present disclosure is not limited thereto.

For example, whether it is the chunk record file may also be determined based on information included in a metadata information file of moving image data.

While the present disclosure has been described above with reference to the embodiments, it is to be understood that the present disclosure is not limited to these embodiments, and various modifications and changes may be made within the scope of the gist of the present disclosure.

The present disclosure may also be realized by executing the following processing. More specifically, software (a program) for realizing the functions of the above-described embodiments is supplied to a system or an apparatus via a network or various storage media and a computer (or control unit or micro processing unit (MPU)) of the system or the apparatus reads and executes the program. In this case, the program and the storage media storing the program constitutes the present disclosure.

While the present disclosure has been described above with reference to the embodiments, it is to be understood that the present disclosure is not limited to the above-described embodiments, and various embodiments within a range not departing from the scope of the present disclosure will be included in the present disclosure. Some of the above-described embodiments may be appropriately combined.

Each functional unit of the above-described embodiments (or modifications thereof) may or may not be individual hardware. The functions of two or more functional units may be realized by common hardware. Each of a plurality of functions of a single functional unit may be realized by separate hardware components. Two or more functions of a single functional unit may be realized by common hardware. Further, each functional unit may be realized by hardware, such as an application specific integrated circuit (ASIC), a field programmable gate array (FPGA), or a digital signal processor (DSP). For example, the apparatus may include a processor and a memory (storage medium) that stores a control program therein. Further, at least a part of the function of the functional unit included in the apparatus may be realized by the processor reading the control program from the memory and executing it.

The present disclosure may also be realized by processing of supplying a program for implementing one or more functions of the above-described embodiments to a system or an apparatus via a network or a storage medium and having one or more processors in a computer of the system or the apparatus read and execute the program. Further, the present disclosure may also be realized by a circuit (e.g., ASIC) that realizes one or more functions.

### Configuration 1 for One or More Embodiments

At least one embodiment of a communication apparatus may include: a transmitter or a transmission unit configured to transmit content data to an external apparatus; a display or display unit configured to display a list screen for a transmission history of the content data; a re-transmitter or a retransmission unit configured to, based on a user operation performed on the list screen to instruct retransmission of a transmission history of content data, retransmit the content data to the external apparatus; and a control unit configured or one or more processors that operate to, in a case where the list screen includes transmission histories of the same content data, restrict a user operation of instructing the retransmission to a part of the transmission histories of the same content data.

### Configuration 2 for One or More Embodiments

At least one communication apparatus according to configuration 1, may have the following be included or occur: wherein the user operation of instructing the retransmission includes a first user operation of selecting content data corresponding to the transmission history as a retransmission target and a second user operation of determining retransmission of the content data selected as the retransmission target, and wherein the re-transmitter or retransmission unit retransmits the content data selected by the first user operation to the external apparatus in response to the second user operation being performed.

### Configuration 3 for One or More Embodiments

At least one communication apparatus according to configuration 2, may have the following be included or occur: wherein the control unit restricts, or the one or more processors restrict, the first user operation in the user operation of instructing the retransmission.

### Configuration 4 for One or More Embodiments

At least one communication apparatus according to configuration 3, may have the following be included or occur: wherein, in a case where the list screen includes transmission histories of the same content data, the control unit restricts the first user operation from being performed on a part of the transmission histories of the same content data.

### Configuration 5 for One or More Embodiments

At least one communication apparatus according to configuration 4, may have the following be included or occur: wherein, in a case where the list screen includes transmission histories of the same content data, the control unit restricts, or the one or more processors restrict, the first user operation from being performed on a transmission history other than a most recent transmission history among the transmission histories of the same content data.

### Configuration 6 for One or More Embodiments

At least one communication apparatus according to any one of configurations 2 to 5, may have the following be included or occur: wherein the display or the display unit displays, in an identifiable manner, that the transmission history on which the first user operation has been performed is the retransmission target.

### Configuration 7 for One or More Embodiments

At least one communication apparatus according to configuration 6, may have the following be included or occur: wherein, in a case where the first user operation is performed on any one of transmission histories of the same content data, the control unit displays or the one or more processors display, in an identifiable manner, that another transmission history of the same content data is the retransmission target.

### Configuration 8 for One or More Embodiments

At least one communication apparatus according to any one of configurations 1 to 7, may further include an acquisition unit configured to acquire the content data from the image capturing apparatus or the one or more processors may further operate to acquire the content data from the image capturing apparatus.

### Configuration 9 for One or More Embodiments

At least one communication apparatus according to configuration 8, may have the following be included or occur: wherein the content data is image data acquired by capturing an image by the image capturing apparatus.

### Methods for One or More Embodiments

A method of control executed by a processor may include: transmitting content data to an external apparatus; displaying, on a display, a list screen for a transmission history of the content data; based on a user operation performed on the list screen to instruct retransmission of a transmission history of content data, retransmitting the content data to the external apparatus; and in a case where the list screen includes transmission histories of the same content data, restricting a user operation of instructing the retransmission to a part of the transmission histories of the same content data.

### Program or Storage Medium for One or More Embodiments

A program, and/or a storage medium having a program stored therein, may be provided in one or more embodiments for causing a computer to function as each unit and/or as the one or more processors or structures of the communication apparatus according to configurations 1 to 9.

According to the present disclosure, even if a plurality of the same contents exists in upload histories, a user may select a retransfer target without confusion.

### OTHER EMBODIMENTS

Embodiment(s) of the present disclosure may also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to, and the benefit of, Japanese Patent Application No. 2025-028372, filed Feb. 25, 2025, which is hereby incorporated by reference herein in its entirety.

What is claimed is:

1. A communication apparatus comprising:
a transmitter configured to transmit content data to an external apparatus;
a display configured to display a list screen for a transmission history of the content data;
a re-transmitter configured to, based on a user operation performed on the list screen to instruct retransmission of a transmission history of content data, retransmit the content data to the external apparatus; and
one or more processors that operate to, in a case where the list screen includes transmission histories of the same content data, restrict a user operation of instructing the retransmission to a part of the transmission histories of the same content data.

2. The communication apparatus according to claim 1,
wherein the user operation of instructing the retransmission includes a first user operation of selecting content data corresponding to the transmission history as a retransmission target and a second user operation of determining retransmission of the content data selected as the retransmission target, and
wherein the re-transmitter retransmits the content data selected by the first user operation to the external apparatus in response to the second user operation being performed.

3. The communication apparatus according to claim 2, wherein the one or more processors restrict the first user operation in the user operation of instructing the retransmission.

4. The communication apparatus according to claim 3, wherein, in a case where the list screen includes transmission histories of the same content data, the one or more processors restrict the first user operation from being performed on a part of the transmission histories of the same content data.

5. The communication apparatus according to claim 4, wherein, in a case where the list screen includes transmission histories of the same content data, the one or more processors restrict the first user operation from being performed on a transmission history other than a most recent transmission history among the transmission histories of the same content data.

6. The communication apparatus according to claim 2, wherein the display displays, in an identifiable manner, that the transmission history on which the first user operation has been performed is the retransmission target.

7. The communication apparatus according to claim 6, wherein, in a case where the first user operation is performed on any one of transmission histories of the same content data, the one or more processors further operates to display on the display, in an identifiable manner, that another transmission history of the same content data is the retransmission target.

8. The communication apparatus according to claim 1, wherein the one or more processors further operate to acquire the content data from the image capturing apparatus.

9. The communication apparatus according to claim 8, wherein the content data is image data acquired by capturing an image by the image capturing apparatus.

10. A method of control executed by a processor, the method comprising:
transmitting content data to an external apparatus;
displaying, on a display, a list screen for a transmission history of the content data;
based on a user operation performed on the list screen to instruct retransmission of a transmission history of content data, retransmitting the content data to the external apparatus; and
in a case where the list screen includes transmission histories of the same content data, restricting a user operation of instructing the retransmission to a part of the transmission histories of the same content data.

11. A non-transitory computer readable medium that stores a program, wherein the program causes a computer to execute a method for controlling a communication apparatus that performs wireless communication with a communication partner apparatus, the method comprising:
transmitting content data to an external apparatus;
displaying, on a display, a list screen for a transmission history of the content data;
based on a user operation performed on the list screen to instruct retransmission of a transmission history of content data, retransmitting the content data to the external apparatus; and
in a case where the list screen includes transmission histories of the same content data, restricting a user operation of instructing the retransmission to a part of the transmission histories of the same content data.
